(19) United States
(12) Patent Application Publication
(10) Pub. No.: US 2007/0208999 A1
(43) Pub. Date: Sep. 6, 2007

(54) Interface Unit For Dentist's or Dental Treatment/Workstation For Passing On Signals Containing Image Information

(75) Inventors: Hermann Gmeinder, Biberach (DE); Richard Schoenenberger, Leutkirch (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH, Biberach (DE)

(21) Appl. No.: 10/575,150

(22) PCT Filed: Oct. 8, 2004
(86) PCT No.: PCT/EP04/11262

§ 371 Date: Dec. 21, 2006

(30) Foreign Application Priority Data
Oct. 8, 2003 (DE) 103 46 670.3

(51) Int. Cl. G06F 3/14

(52) U.S. Cl. 715/700

(57) ABSTRACT

An interface unit for employment at a dentist's or dental treatment/workstation, which is provided for the purpose of passing on signals containing image information, has at least two inputs for receiving input signals containing image information, at least two outputs for passing on output signals containing image information to one or more displays connectable with the interface unit and/or to further interface units, and at least one internal transfer unit for selectively passing on of the input signals containing image information to the outputs. There is further provided a processing unit for conversion of an analog video input signal into an output signal corresponding to a PC standard.

The present invention relates to an interface unit for employment at a dentist's or dental treatment/workstation which is provided for the purpose of passing on signals containing image information.

Modern dentist's or dental treatment stations or work stations often have one or more displays or monitors, on which information is represented. This information may thereby be of very varied nature and in particular originate from very varied sources. A first source for image information is for example examination devices, which produce images of a tooth to be treated or of the jaw region. To these there belong for example so-called intra-oral cameras or modern X-ray examination devices, which directly produce a digital X-ray image of the examined region.

Beyond this, the normal working and treatment apparatuses often also deliver information which is represented on a display. Thus, in modern dental treatment stations displays are often already integrated, on which current operating parameters of working tools used are represented. For example there are represented on such displays the speed of rotation and the torque of a drill handpiece currently being employed. Also measurement data of other examination devices, for example optical caries diagnosis devices, are represented on the display, whereby in the meantime there is even the possibility of combining the representation of the measurement values with a simultaneous optical representation of the examined tooth. Finally, there can be represented on the display also information relating to the patient.

A final category of devices making available image information is represented by classical video devices such as for example DVD or VHS players, which are employed for example to make available background information concerning a care or treatment measure to be carried out or to make available general explanations concerning dental hygiene for the patients.

From the above explanation, it is apparent that at a dentist's work or treatment station the most varied image information is available, which can be represented on a display. Here it is to be taken into account that the different image information is based in part on very different formats, whereby in each case a suitable control of the display must be provided. Beyond this it must be ensured that the image information made available from the different devices is also in fact passed on to the desired display. Here there arises the additional problem that often also a plurality of displays are available at a treatment station. Although a respective individual connection of the displays to the different devices would be conceivable, the association of the different image sources to the different displays within the treatment room or the entire practice, with the use in each case of separate lines and cables, is however, complex and fault-prone.

From WO 03/099111 A1 there is known a connection device for a dentist's work station to which a plurality of image-providing sources can be connected simultaneously. Depending on the selection made, one of the input side video signals can then be directed to an output and represented on one of the screens associated with the connection device. Also the passing on of analog video signals to a separate PC is possible, by means of which then the conversion into a VGA signal and the representation of the information on a PC monitor is effected. Further, various video interfaces are known, with the aid of which a plurality of input side analog video signals can be selectively passed on to different outputs.

The present invention is now based on the object of indicating an improved possibility of depicting, on one or more displays, the various image information available at a dentist's treatment or work station in a comfortable and simple manner, in particular however also in a manner which is as flexible as possible.

This object is achieved by means of an interface unit having the features of claim 1, which is provided for employment at a dentist's or dental treatment/workstation.

Thereby, the interface unit in accordance with the invention has

at least two inputs for receiving input signals containing image information,

at least two outputs for passing on output signals containing image information to one or more displays connectable with the interface unit and/or to further interface units, and

at least one internal transfer unit for selective passing on of the input signals containing the image information to the outputs,

whereby further a processing unit for conversion of an input side analog video signal into an output signal corresponding to a PC standard, in particular corresponding to the VGA standard, is provided.

The central concept of the present invention is thus that with the aid of the internal transfer unit a plurality of input signals containing different image information can be selectively passed on to different outputs and thus different devices, whereby in particular the possibility of conversion of analog signals into signals corresponding to a PC standard is made possible, so that without the intermediary of a PC the information can also be represented directly on a PC monitor. The devices which can be connected to the interface unit in accordance with the invention may be in particular displays on which image information can be directly represented. It would, however, also be conceivable to pass on the signals to a further interface unit, which then for its part passes on the signals to a further device. As will be explained below in detail, through this there can be formed, so to say, a network for the transfer and passing on of image information.

With the aid of the interface unit in accordance with the invention it is for example possible to operate two displays at a dentist's treatment/workstation and to represent in each case different information on the displays. Should now a change be effected with regard to the information which is represented on the displays, it is thus no longer necessary to newly connect the displays with the corresponding image-providing device. Instead, merely corresponding selection information must be passed on to the interface unit, which in response automatically internally passes on the image information to the corresponding output. The danger of an incorrect connection between an image producing unit and a display unit is thus excluded.

In accordance with an advantageous exemplary embodiment of the present invention, the interface unit in accordance with the invention has at least two inputs and outputs for video signals, wherein a first transfer unit is provided which passes on the video input signals in the above-described manner selectively to the outputs. There may further be provided a digital processing unit, with the aid of which image signals can be processed and issued in a modified form. This digital processing unit may be provided for example for the purpose of producing still images from certain video items, which can then be represented on the or a further supplementary display. Also the simultaneous representation of a plurality of images on a single screen is possible through this. An image modified by the digital processing unit can in particular again be delivered to the first transfer unit and passed on at the video output, there being however also the possibility of converting this still image into a corresponding signal corresponding to the VGA and/or DVI standard, and passing on this signal to a suitable display. The processing unit has for this purpose a processing block for modification of the digitalised analog video signal, a conversion unit for the production of a VGA signal and a further conversion unit for the generation of a DVI signal.

In the case of the input signals containing image information delivered to the interface unit in accordance with the invention, there may in particular be involved also signals corresponding to the VGA standard or another PC graphic standard. Such signals are for example made available by control units of dentists' working or treatment devices and serve for the purpose of displaying current operating parameters or examination results. Preferably it is in turn provided that the interface unit has at least two inputs for such VGA signals and two corresponding outputs, wherein a second transfer unit is provided via which the digital input signals are selectively passed on to the outputs.

Finally it is also to be taken into account that the signals containing image information are often linked with audio signals. In order to be able to take account of this, the interface unit may further have two inputs and outputs for audio signals, which in each case are associated with the inputs and outputs for the signals containing image information, and an audio transfer unit, via which the audio signals at the inputs are passed on to the associated outputs in correspondence to the passing on of the signals containing image information. The audio transfer unit thus ensures that a video signal issued from the interface unit is in principle also linked with the correct audio signal.

The interface unit in accordance with the invention in particular brings advantages when a networking of different practice rooms is carried out. With the aid of the interface unit there is now the possibility of employing a central media server—for example a PC, a DVD player or a VHS player—the output signal of which is transmitted to a first work station with a first display and from there passed on to further practice rooms. At each work station a desired video item can then be represented. With the aid of the processing unit there is further the possibility of producing still images from certain video items, which are then represented on a or further displays, in particular also on the displays located in other treatment rooms.

A further aspect of the present invention is concerned with the control of the interface unit in accordance with the invention, that is, the input of that information which determines which image information is passed on to which output. Along with a manual input at the device itself it can thereby in particular be provided to carry out the control from a central point. For this purpose there may be provided an input device for the generation and wireless transfer of control information for the control of the interface unit, whereby the information generated by the input device is preferably not directly delivered to the interface unit but initially to a functional unit, which receives the information transferred from the input unit and passes it on to the interface unit. The interface unit may then be integrated in the functional unit or represent a separate device, whereby in the second case the passing on of the information received in a wireless manner by the functional unit is preferably likewise carried out in a wireless manner.

The operating device, which amounts to remote control, thus makes possible the control of the interface unit from a central point, whereby for a user of the dentist's treatment or workstation it is no longer necessary to directly seek out the interface unit in order to carry out a new ordering of the passing on of signals. The wireless transfer of the control information from the functional unit to the interface unit or units has beyond this also the advantage that upon a new arrangement of the individual devices the new laying of cables is not necessary. Instead, the devices can resume their work directly after their new positioning.

In this connection it is to be noted that this wireless control of the interface units can also be extended to other working or treatment devices of the dentist's station. Thus, the interface unit in accordance with the invention represents merely a certain type of device, which can be remotely controlled in the above described manner.

In order to make possible disruption-free data traffic between the various devices and the functional unit, it is preferably provided that the functional unit represents a so-called master module within the context of the radio traffic, whilst in contrast the further devices form slave modules. A data transfer from the side of the devices to the functional unit is thus effected preferably only after a request on the part of the functional unit, so that the case cannot arise that a plurality of devices transfer data simultaneously. Also the input device represents in this case a slave unit, which however is contacted repeatedly at short time intervals by the master module, in order to detect possible new information. Further, after taking up of contact between the functional unit and one of the devices, also the possibility of a bidirectional data transfer would be conceivable.

The present invention thus opens up the possibility of realizing a dentist's or dental work or treatment station which can be operated very comfortably. In particular the most varied image-providing data can be coupled out in a desired manner or delivered to certain display units, so that multiple possibilities for the representation of image-providing information are attained.

Below, the invention will be described in more detail with reference to the accompanying drawings. There is shown:

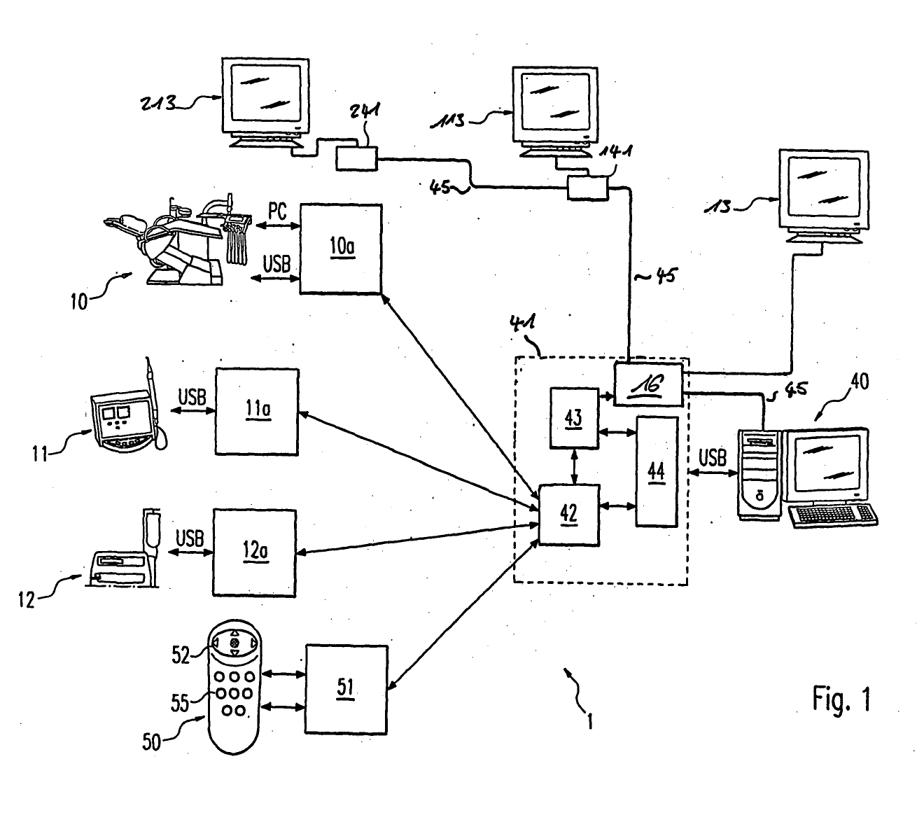

FIG. 1 schematically, the concept of wireless central control of various devices of a dentist's or dental treatment/workstation;

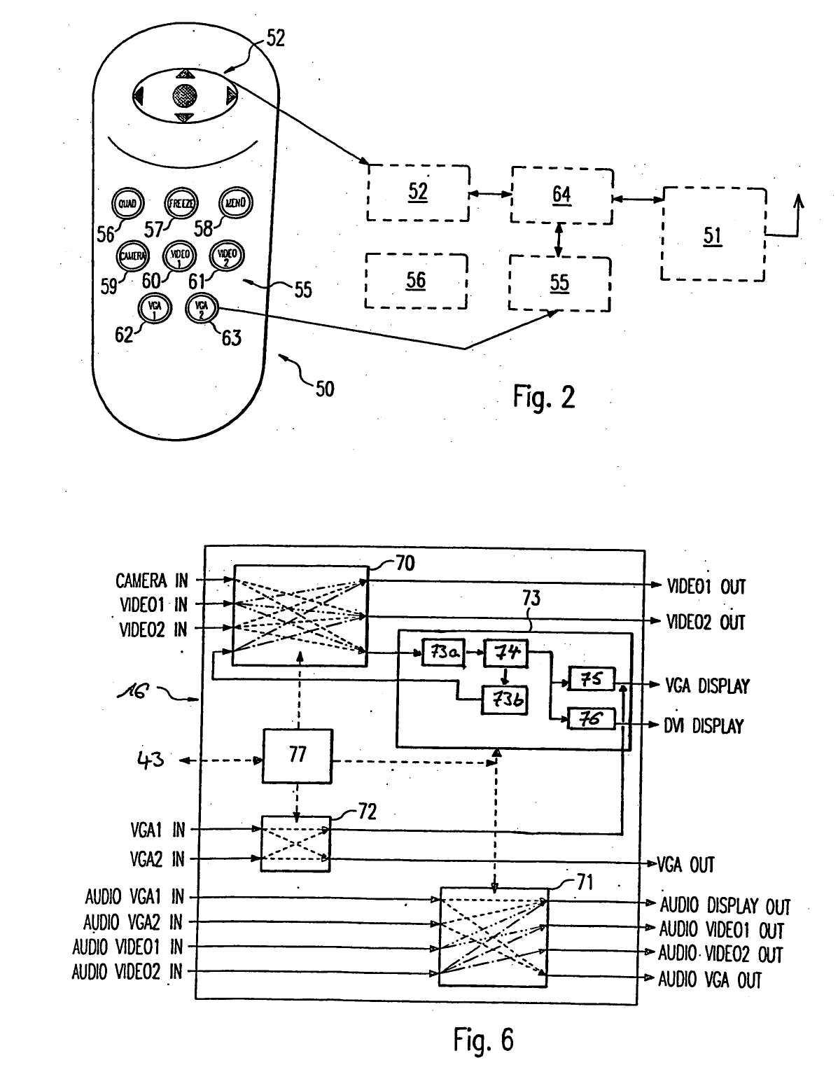

FIG. 2 an exemplary embodiment of an input device for the generation of navigation and control information;

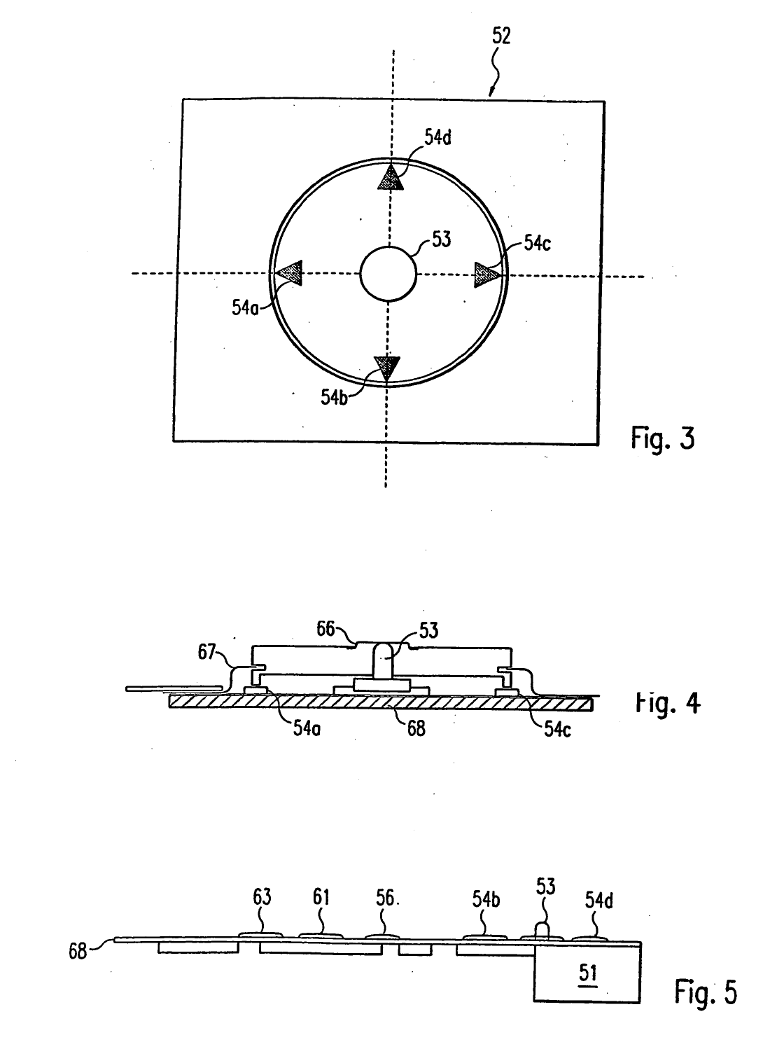

FIG. 3 a representation to an enlarged scale of a first input element of the input device for the generation of navigation information;

FIG. 4 the first input element represented in FIG. 3, in side section;

FIG. 5 the arrangement of various components for the realization of the input device represented in FIG. 2;

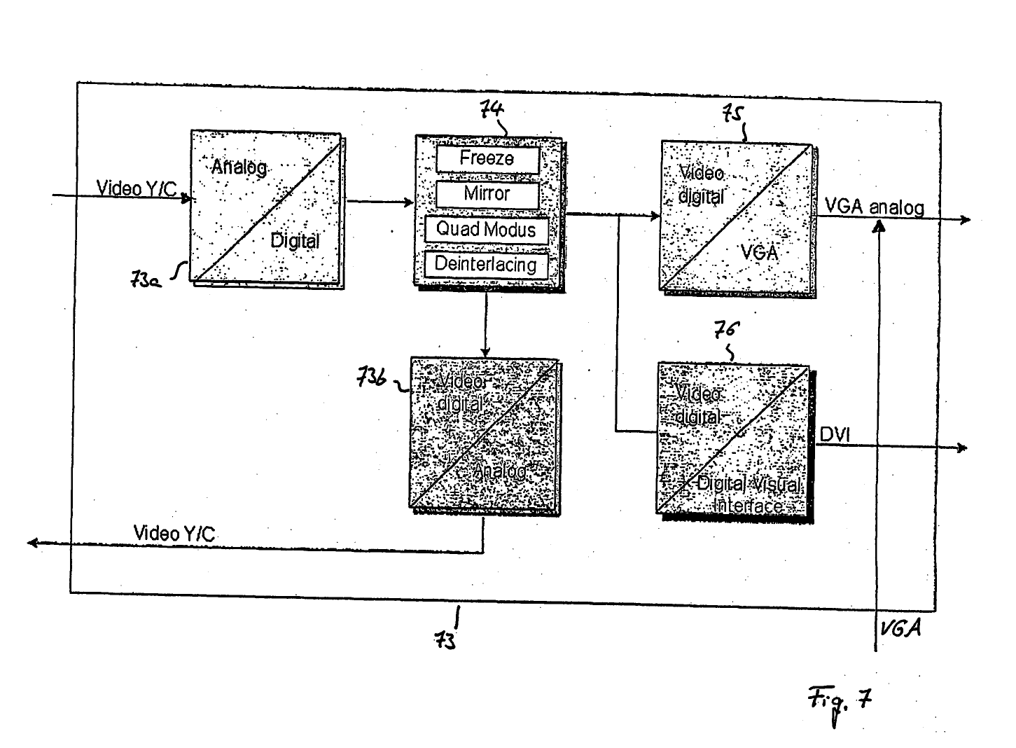

FIG. 6 a block circuit diagram of an interface unit in accordance with the invention and

FIG. 7 a representation of an enlarged scale of a central element of the interface unit.

The dentist's or dental treatment or work station represented in FIG. 1, and designated in its entirety by the reference sign 1, has first a series of different devices which find employment in the activities of a dentist or dental technician. By way of example there are illustrated a dentist's treatment chair 10 with the associated treatment devices, a laser diagnostic device 11 and a dental motor handpiece 12. To these devices there belongs in the sense of the present application, beyond this, also an interface unit 16 associated with a display 13, which is part of a so-called functional unit 41 and the task of which is to deliver to the display 13 suitable image and, if applicable, audio information. The functioning of this interface unit 16 will be described in more detail below.

The working of the various devices is coordinated or monitored primarily by means of a central server 40, which usually is arranged at a certain distance from the treatment chair 10, for example in a cupboard or even in a separate room of the practice. The control of the various devices is effected at least in part with the aid of the functional unit 41, which transfers control commands to the various devices in a wireless manner, or receives data from these devices. The more precise functioning of this functional unit 41 will be described in more detail below. It is further connected both with the server 40 and also with further functional units 113, 213 (if applicable arranged in other rooms of the practice) via additional data or video lines 45, over which the signals containing the image and audio information can be transferred. Through this there is realized a kind of practice-internal network, with the aid of which image information made available from various sources can be selectively represented on the displays 13, 113, 213 associated with the three functional units 41, 141, 241.

The control and monitoring of certain functions of the devices of the dentist's or dental treatment/work station is effected in two different manners.

First, it is possible to directly call up certain selected functions of individual devices and, if applicable, to activate them. For example, by means of a single command the optical diagnosis device 11 could be started, the treatment chair 10 brought to a certain starting position or a certain image signal delivered to the display 13. Other functions of the devices require, however, the additional indication of certain parameters, in order to be able to activate these functions in desired manner. Thus, for example, a simple switching on of a dental X-ray apparatus would not be sufficient, since beyond this there must also be transferred information regarding the desired dose or the desired exposure time.

In order to be able to call up also these more complex functions from a central point, the control of the devices in this case is effected with the aid of a user interface represented on a display. For this purpose there is represented for example on the screen 13 or on the display of the server 40 a menu in which the various functions of the device to be controlled can be selected and set. Here, a pointer is then navigated over the user interface, in order to select certain switching areas and to be able to enter desired parameters.

If the server 40 is at a different position than the various devices of the work station, a central control of the devices via the server 40 is rather inconvenient, since to call up a new function or for setting a new parameter in each case the server 40 would have to be sought out. In this case, the individual operation and de-central control of the devices would be significantly more convenient.

In accordance with an advantageous further development of the present invention, the central control of the various devices is however facilitated by means of the employment of an input device 50, with the aid of which control information can be entered and transferred to the various devices in a wireless manner. The input device 50, the configuration of which will be described in more detail below, stands in contact with the functional unit 41 via a transmission and reception unit 51, which receives information transferred from the input device 50 and passes it on in appropriate manner as control commands to the devices of the treatment or work station or to the server 40. The functional unit 41 thereby stands in contact with the server 40 via a USB interface, in order to be able to fully exploit the possibilities of central control of the various devices.

Components of the functional unit 41 are first a transmission and reception unit 42, a controller 43, a so-called USB hub 44, providing the connection to the server 40, and the above-mentioned interface unit 16 for control of the associated display 13. The connection between the functional unit 41 and the server 40 is necessary in particular because a plurality of items of information received from the operating unit 50—in particular when they relate to the control or monitoring of an apparatus within the scope of a user interface represented on a display—must first be processed by means of the server 40 before they can be passed on, if applicable as appropriate control commands, to the devices. For this purpose there serves the internal controller 43 of the functional unit 41, which passes on the information received from the server 40 to the transmission and reception module 41. The interface unit 16 is also controlled by the controller 43. Thereby it is to be taken into account that in the case of the described exemplary embodiment of the present invention, also a control of the devices 10, 11, 12 is effected via the server 40, whereby these devices 10, 11, 12 have control commands issued from the server 40 passed thereto by means of the functional unit 41, which control commands are then appropriately put into effect by the devices 10, 11, 12. However, a simplified version would also be conceivable of employing the server 40 solely for the monitoring of the devices 10, 11, 12 and for documentation. The devices 10, 11, 12 would then receive no control commands from the server 40 but solely for their part transfer information via the functional unit 41 to a server 40, which is then represented on the display. This information could both relate to the current operating condition of the devices 10, 11, 12 and also contain measurement results, e.g. image data detected by an intra-oral camera. An at least partial control of the devices 10, 11, 12 could in this case, however, still be effected via the selection keys of the input device 50, the control information of which is preferably transferred independently of the server 40.

The control or communication of the various devices with the functional unit 41 is again effected preferably in a wireless manner. The control commands transferred from the transmission and reception unit 42 are then received by transmission and reception units, (explicitly represented in FIG. 1 are the transmission and reception units 10a, 11a and 12a of the treatment chair 10, of the optical diagnosis device 11 and of the motor handpiece 12) associated with the respective devices and delivered to the devices in digital form. Usually, the individual devices are thereby connected with the appropriate transmission and reception units via USB interfaces, but alternatively or additionally thereto there can also be employed a conventional PC interface, as is illustrated in the case of the treatment chair 10.

Before the configuration of the operating device 50 is explained in more detail, it should be mentioned that the data communication between the functional unit 41 and the various transmission and reception units of the devices is effected in accordance with the master-slave principal. Here, the transmission and reception unit 42 of the functional unit 40 represents the master module, which of itself can at any time transfer signals to the other units, which form the slave modules. For their part the slave modules transfer information however only after a request from the master module 42. In this manner a disruption-free data traffic between the individual units is ensured. Alongside this, however, in certain cases the start of a data transfer can also be initiated by a slave unit. Further it can be provided that after the login of a device a bidirectional data transfer between the functional unit and the device is permitted.

Although it would also be conceivable to connect the various devices of the work station via data lines with the functional unit 41 or with the server 40, the illustrated wireless communication between the functional unit 41 and the various devices however brings certain advantages. Thus, on the one hand, through this obstacles for a person moving in the room are avoided. Beyond this, the devices can be newly arranged in simple manner, without the laying anew of communication lines being necessary.

In the following the precise structure of the input device 50 is to be explained. As has already been explained, in the case of a central control of the different devices a distinction is to be made between such functions which can be selected or monitored via a user interface represented on a display, thus by which a navigation through the user interface is necessary, and such functions which can be directly called up and activated. In order to be able to take account of these different requirements, the operating device 50 in accordance with the invention has two different input elements, namely a first input element 52 for the generation of navigation information for the control of a pointer on the user interface, and a further input element 55 for the generation of control information with which, independently of the navigation information generated by means of the first input element, certain functions of the devices can be directly called up and activated.

It can be understood from the illustrations to enlarged scale in FIGS. 2 and 3, that the first input element has a navigation element 53 for the generation of two-dimensional navigation information and additional selection keys 54a to 54d for the generation of supplementary selection information. The navigation element is in particular a joystick 53, which is operated for initiating a synchronous movement of a pointer on the user interface. If a user holds the input device 50 in the hand, he can tilt the joystick 53 with the aid of his thumb in simple manner in the desired direction, in order to navigate the pointer corresponding to the selected direction over the user interface. In this sense, the joystick 53 assumes the function of a conventional computer mouse. In order to further complete this “simulation” of a computer mouse, the additional selection keys 54a to 54d are provided, which are arranged to the four sides of the joystick 53. By means of a pressing down of the input element 52 in the region of one of these selection keys 54a to 54d there can be generated and transmitted supplementary selection commands. In particular thereby, the functions of the right and left selection keys 54a and 54c correspond to the functions of the right and left mouse keys. The first input element 52 thus offers all functions which are available in similar manner with a conventional computer mouse.

In the illustrated preferred exemplary embodiment, beyond this the joystick 53 has further also a switching function in the third dimension, i.e. alongside tilting it can also be pressed down. Through this the possibility is provided, in addition to the four selection keys 54a to 54d, of generating a further, fifth selection command.

The information generated during a so-called navigation mode, within the scope of actuation of the first input element, is then made available with the aid of a serial RS232 or UART interface and transformed by a microcontroller 64 into a transmissible protocol, which is issued via the transmission and reception unit 51 and sent to the functional unit 41. The functional unit 41 in turn communicates via the USB interface with the server 40, which in the end transforms the navigation information into a movement of the pointer over the user interface represented on the display.

The user interface itself may for example be represented on the display 13 which is associated with the functional unit. The image information necessary for this is generated in the server 40 but can be passed on via the lines 45 to any desired display, to which in particular the interface units located in the functional units 41, 141, 241 contribute. The dentist located at the treatment chair 10 then has the possibility of carrying out the central control of the individual devices, made available by the server 40, directly from his current work station. In particular he need not actuate an input device located at the server—e.g. the computer mouse connected with the server—in order to be able to navigate through the various menu points of the user interface.

FIG. 4 shows an exemplary embodiment for the realization of a first input element 52. The joystick and the various selection keys 54a to 54d are thereby arranged on a board 68 and held by means of rubber bearings 66 and 67. Upon a pressing down or tilting of the rubber bearing into a desired position corresponding switches are then activated, through which the desired selection information is generated.

In contrast to the first input element 52, which is responsible for the generation of navigation information, the second input element 55 serves—as already mentioned above—for purposively activating certain functions of the individual devices. For this purpose the second input element 55 is formed as a function key field, which in the illustrated exemplary embodiment has overall eight function keys 56 to 63. The information generated by a pressing down of these function keys is delivered by a further interface circuit 55 likewise to the microcontroller 64, which again converts this information into a transmissible protocol and transfers it to the transmission and reception unit 51. Beyond this, the input device 50 has a battery supply 56, which makes possible a cordless operation of the device.

FIG. 5 shows again, in side section, a possibility for realizing the input device in accordance with the invention. The various elements are thereby arranged in the form of a joystick and a plurality of foil keys on the circuit board 68, at the underside of which there are located the electrical components and the transmission and reception unit 51.

Below, the functions of the individual function keys 56 to 63 of the second input element 55 are to be explained. Of course a specific exemplary embodiment is involved here, in which the function keys 56 to 63 are primarily provided for the control of the interface unit 16 located in the functional unit 41. Naturally, the keys can however be occupied with other functions for control of one of the devices 10, 11 or 12.

The three upper keys 56 to 58 serve in the illustrated example for the control of the image representation on the display 13 associated with the interface unit 16. With the aid of the first key (“QUAD”) the representation can thereby first be switched over on the display 13 into a so-called QUAD representation, in which four different video images are represented at the same time on the screen. In particular there is opened up through this the possibility of combining the representation of a live image with the simultaneous display of three still images, or e.g. to represent four still images at the same time.

The second key 57 (“FREEZE”) serves to “freeze” the image currently transferred from the selected image source, that is, to generate a still image on the display.

The right key 58 serves exclusively for the purpose of changing from the above-described navigation mode into a so-called menu mode in which the further navigation through the user interface represented on the display is effected not on the basis of a two-dimensional displacement of a pointer, but through the change between various menu points. This menu mode also has effect on the functioning of the first input element 52, since here only the four selection keys 54a to 54d are active and serve for the purpose of changing to a right, left, upper or lower menu point. The joystick 53 itself is inactive during the menu mode and the serial RS232 interface is blocked.

The functional keys 59 to 56 of the two lower rows of the key field 54 serve exclusively for the selection of an image source the information of which is to be represented on the display 13. Thus, via these keys it is determined which image signal of the work station is passed on to the display 13. With the aid of the three upper keys 59, 60 and 61 change between the intra-oral camera and two further video input signals can be effected, whilst in contrast the two lower keys 62 and 63 are provided for selection of a VGA input signal. With the aid of these two lower keys it can for example be selected from which computer—for example from the server 40 or a computer (not shown) associated with the treatment chair 10—image information is transferred to the display 13 and is to be represented.

As has already been mentioned, there is of course also the possibility of allocating other functions to the function keys of the key field. For example these keys can be employed for the purpose of activating certain basic settings of various devices—of the patient chair or of the optical diagnosis device. Likewise it would be conceivable to allocate to all or at least some of the keys in each case changeable functions, which are newly defined in dependence upon the kind of the menu point presently selected on the user interface. It is significant, however, that the navigation information generated with the aid of the first input element 52 is passed on to the server 40, in order to make possible through this navigation on the screen interface and therewith, if applicable, an indirect control of the devices 10, 11, 12, whilst in contrast the information generated upon the actuation of the individual function keys 56 to 63 brings about a direct control of the corresponding device. In the illustrated exemplary embodiment e.g. the functional unit 41 or the interface unit 16 located therein is controlled directly and without the intermediary of the server 40.

Overall the operating device 50 thus opens up the possibility of controlling the various devices of the treatment station in a comfortable manner, without having to seek out for this each time a specific input device at the server 40 responsible for the central control.

From the above explanations it is apparent that at a dentist's work and treatment station the most varied image information is available, which can be brought for representation on a display. This image information can be made available from the most varied sources. A conceivable source would be, for example, an intra-oral camera, the images of which are represented on a display during the examination, or an examination device, e.g. a dentist's X-ray apparatus the examination results of which in the form of X-ray images are likewise to be shown on the display. A PC—e.g. the server 40—of course also represents a further image source, via which information concerning the patient or operating parameters of the examination or treatment device currently being used is represented.

Since the allocation of the various image information to the various displays within the treatment room or the overall practice is complex and subject to error with the employment in each case of separate lines and cables, there will be described below a possibility of allocating the various image information individually to certain displays. This task is fulfilled by an interface unit 16 in accordance with the invention connected upstream of the displays 13, 113 and 213, which will be explained in more detail below with reference to FIGS. 6 and 7.

The task of the interface unit 16 is, as mentioned, to select from the plurality of image information items available a desired signal and to deliver this to the allocated display as output signal. For this purpose the interface unit 16 has overall four internal units, a first transfer unit (the so-called video matrix 70), an audio transfer unit or audio matrix 71, a second transfer unit (the so-called VGA matrix 72) and a digital processing unit 73. All four units are controlled from a central controller 77 which coordinates the functions of the four units amongst one another. The controller itself is controlled by the controller 43 of the functional unit 41, in which the interface unit 16 is integrated in the case of the illustrated exemplary embodiment. In an alternative configuration, the interface unit 16 could, however, also be a separate device, which can be controlled via the input device 50 in a wireless manner, and if applicable via the server 40 and the functional unit 41, just as the further devices 10, 11, 12 of the dentist's or dental treatment or workstation.

The task of the video matrix 70 is to switch four different input signals in any chosen manner to three outputs. Here, input signals are delivered to the video matrix 70 via three external terminals (CAMERA IN, VIDEO1 IN, VIDEO2 IN) and an internal terminal connected with the processing unit 73. In accordance with the requirements of the controller 77 the video matrix 70 then associates the corresponding input signals to three outputs, whereby two of the outputs (VIDEO1 OUT and VIDEO 2 OUT) may be connected directly with a display unit—for example a video screen. These outputs may, however, also be employed for the purpose of passing on the video signal to a further interface unit or to the functional units 141, 241 with interface units located therein, through which a networking of the interface units of a dentist's practice amongst one another is attained. The third output of the video matrix 70 finally leads to digital processing units 73, which is employed for the purpose of processing the video image.

Internally, the processing unit 73, has, corresponding to the illustration in FIG. 7, for this purpose first a conversion block 73a, which converts the analog video signal into a digital signal. The digital signal can then be selectively processed in a processing block 74, whereby in accordance with the illustration there are available the possibilities “freeze”, “mirror”, “quad” and “deinterlacing”. The video signal processed in this manner can then either—after prior conversion into an analog signal by means of a further conversion block 73b—be delivered again to the video matrix 70 and via this to one of the video outputs or to two further conversion blocks 75 and 76. These further conversion blocks 75 or 76 are responsible for forming from the digital video signal a signal corresponding to the VGA standard or the DVI (digital video interface) standard. The VGA signal can then be delivered to an output (VGA DISPLAY) which is for example connected with a computer monitor, whilst in contrast the DVI signal is delivered to a further output (DVI DISPLAY). Significant here is that the processing unit 73 opens up in particular also the possibility of converting the input analog video data “live” into signals corresponding to the VGA standard, so that without the intermediary of a further device an immediate representation also of moving images is made possible on a PC monitor.

Supplementary to the processing of the video input signals, the interface unit 16 can also process two VGA input signals via the two input signals VGA1 IN and VGA2 IN. Both inputs are connected with the VGA matrix 72 to which there are delivered the signals selectively either of the processing unit 73 for passing on to a VGA display or to a further output (VGA OUT) for passing on to a further unit—for example the server or the like.

It is to be noted that the mentioned VGA standard is mentioned merely by way of example. Of course, the processing unit 73 and the second conversion unit 72 could also be provided to process or to generate signals corresponding to another PC graphic standard, whereby, however, also for the other graphic standards the possibility of “live” conversion of analog video signals is available.

Often, the video or VGA input signals are also combined with audio information. In order to take this into account in the passing on of the various image providing signals, the audio matrix 70 is provided for the purpose of passing on the audio signals associated with the two video input signals and the two VGA input signals in desired manner to the corresponding video and VGA output terminals. In this way it is ensured that an audio signal associated with an input image signal is also connected to the corresponding associated output lines.

The employment of the interface unit 16 in accordance with the invention now opens up the possibility of connecting different displays, which are arranged in one or different practice rooms, with one another, via a network. For example, a media server can be set up in a central location, which may be a PC or a video device such as e.g. a DVD or a video player, the output signals of which (video and audio) are transmitted to a first work station and from there to the further practice rooms, more precisely passed on to the further interface units located in these practice rooms. Through this it can be ensured that at each work station the same video item can be shown. This possibility of networking is made possible by means of the connection of a plurality of functional units, with interface units arranged therein, as is illustrated in FIG. 1. Thereby, for example, the functional units 141, 241 with their associated displays 113, 213, may be arranged in other practice rooms, whereby via the lines 45 the network for the selective passing on of image and audio information is formed.

A further exemplary embodiment consists in forming a still image from a signal delivered by the intra-oral camera and to pass on via the interface unit(s) this still image to one or more work stations. In particular different image signals can be passed on selectively to different displays. Significant here is that the different outputs of the interface unit in accordance with the invention can be selectively occupied with the desired image signals, whereby if applicable the associated audio information is passed on in the same manner.

By means of the interface unit in accordance with the invention the passing on of video and audio signals is thus significantly facilitated. In particular it is no longer necessary to lay from an image providing unit in each case a plurality of lines to the various display units.

Thus, overall the present invention opens up the possibility of realizing a dentist's or dental work or treatment station which is comfortable to operate. Thus, a central control of the various devices is made possible with the aid of a remote control, by means of which the advantages of a networking of the devices amongst one another can be effectively exploited. At the same time the most varied image-providing data can be coupled out or delivered to certain display units in desired manner, so that many possibilities for representation of image-providing information are attained.

1. Interface unit for employment at a dentist's or dental treatment/workstation, which is provided for the purpose of passing on signals containing image information,
wherein the interface unit has the following features:
at least two inputs for receiving input signals containing image information,
at least two outputs for passing on output signals containing image information to one or more displays connectable with the interface unit and/or to further interface units and
at least one internal transfer unit for selectively passing on of the input signals containing image information to the outputs,
and wherein the interface unit further has a processing unit for conversion of an analog video input signal into an output signal corresponding to a PC standard.

2. Interface unit according to claim 1,
wherein
the processing unit has on the input side a first conversion block for conversion of the analog video signal into a digital signal.

3. Interface unit according to claim 2,
wherein
the digital signal produced by the first conversion block can be delivered to a processing block for digital processing of the video signal.

4. Interface unit according to claim 2,
wherein
the digital signal produced by the first conversion block, and if applicable processed by the processing block, can be delivered selectively to the first transfer unit or to at least a further conversion unit for the generation of a signal corresponding to a PC graphic standard.

5. Interface unit according to claim 4,
wherein
the second conversion unit forms an output signal corresponding to the VGA standard.

6. Interface unit according to claim 5,
wherein
the digital signal produced by the first conversion block, and if applicable processed by the processing block, can be delivered to a third conversion unit for the generation of an output signal corresponding to the DVI standard.

7. Interface unit according to claim 1,
wherein
this has at least two inputs and two outputs for video signals, and a first transfer unit via which the video input signals are selectively passed on to the outputs.

8. Interface unit according to claim 1,
wherein
at least one input signal is a signal corresponding to a PC graphic standard.

9. Interface unit according to claim 8,
wherein
this unit has at least two inputs and two outputs for signals corresponding to the PC graphic standard and a second transfer unit via which the signals are selectively passed on to the outputs.

10. Interface unit according to claim 8,
wherein
the signals corresponding to the PC graphic standard are VGA signals.

11. Interface unit according to claim 1,
wherein
this unit further has at least two inputs and outputs for audio signals, which in each case are associated with the inputs and outputs for the signals containing image information, and an audio transfer unit via which the audio signals at the inputs are passed on to the associated outputs in accordance with the passing on of the signals containing the image information.

12. Dentist's or dental treatment/workstation, having
an interface unit in accordance with any preceding claim, and at least one further device, in particular a dentist's work and/or examination device,
an input device for the generation and wireless transmission of navigation and/or control information for activation and control of functions of the interface unit or of the devices, and
a functional unit, connected upstream of the devices, which receives the navigation and/or control information transmitted from the input device and passes it on to the devices.

13. Dentist's or dental treatment/workstation according to claim 12,
wherein
the interface unit is integrated in the functional unit.

14. Dentist's or dental treatment/workstation according to claim 12,
wherein
the functional unit passes on the navigation and/or control information transmitted from the input device at least in part in a wireless manner to the devices.

15. Dentist's or dental treatment/workstation according to claim 14,
wherein
the functional unit has a master module for wireless communication with the devices, whereby there is associated with the devices in each case a slave module which passes on the information received from the master module to the associated device.

16. Dentist's or dental treatment/workstation according to claim 15,
wherein
the slave modules are integrated in the respective devices or connected with these via an RS232 interface and/or a PC interface.

17. Dentist's or dental treatment/workstation according to claim 12,
wherein
the functional unit further stands in connection with a server, wherein there is effected an exchange of data between the server and the devices via the functional unit.

18. Dentist's or dental treatment/workstation according to claim 17,
wherein
the functional unit is connected with the server via a USB interface.

19. Dentist's or dental treatment/workstation according to claim 12,
wherein
the input device has:
a first input element for the generation of navigation information for the control of a pointer on a user interface which is represented on a display of the dentist's treatment station,
at least a second input element for the generation of control information with which functions of the devices are selectable and/or activatable independently of the navigation information generated by the first input element,
transfer means for the wireless transmission of the navigation and control information generated with the aid of the first and second input elements to the devices or to a functional unit connected upstream of the devices.

20. Dentist's or dental treatment/workstation according to claim 19,
wherein
the control information generated via the second input element can be employed for the control of the at least one device independently of a unit administering the user interface.

21. Dentist's or dental treatment/workstation according to claim 20,
wherein
the first input element has a navigation element for the generation of two-dimensional navigation information and at least two selection keys for the generation of supplementary selection information.

22. Dentist's or dental treatment/workstation according to claim 21,
wherein
the navigation element is a joystick.

23. Dentist's or dental treatment/workstation according to claim 22,
wherein
the joystick can be pressed down for the generation of a supplementary item of selection information.

24. Dentist's or dental treatment/workstation according to claim 22,
wherein
in a menu mode the functioning of the navigation element is blocked, and solely the selection information can be generated with the aid of the selection keys.

25. Dentist's or dental treatment/workstation according to claim 22,
wherein
the second input element is formed by a function key field having a plurality of function keys.

26. Dentist's or dental treatment/workstation according to claim 25,
wherein
a part of the function keys is provided for control of the interface unit.

27. Dentist's or dental treatment/workstation according to claim 26,
wherein
a part of the function keys is provided for selection of a video image source intended for representation on a display.

28. Dentist's or dental treatment/workstation according to claim 26,
wherein
a part of the function keys is provided for the selection of an image signal corresponding to a PC graphic standard, in particular corresponding to the VGA standard, intended for representation on a display.
